(19) United States
(12) Patent Application Publication
(10) Pub. No.: US 2007/0104064 A1
(43) Pub. Date: May 10, 2007

(54) Method and apparatus for two dimensional optical storage of data

(76) Inventors: Alexander Mark Van Der Lee, Eindhoven (NL); Christopher Busch, Eindhoven (NL); Dominique Maria Bruls, Eindhoven (NL); Peter Coops, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/581,642

(22) PCT Filed: Nov. 30, 2004
(86) PCT No.: PCT/IB04/52593

§ 371 Date: Jun. 5, 2006

(30) Foreign Application Priority Data
Dec. 8, 2003 (EP) 03104578.4

(51) Int. Cl. G11B 7/00

(52) U.S. Cl. 369/53.22

(57) ABSTRACT

The invention relates to a data processing system comprising a computer having a memory for storage and retrieval of at least one application program embodying a pre-determined functionality, and for storage and retrieval of at least one data-file, which computer comprises a user interface for entertaining communication between the computer and a user of said computer, whereby the at least one application program comprises validation software for checking and enabling the operability of said application program in connection with the at least one data-file, and processing software for executing the said functionality in connection with the at least one data-file in dependence of said enabling by the validation software, whereby the validation software is executable separately and independent from the processing software.

This invention relates to a method and apparatus for two dimensional optical storage of data and, more particularly, to a method and apparatus for improved write and read quality of data stored on two dimensional optical storage media.

Storage capacities in digital optical recording systems have increased from 600 MB per disc in CD to 4.7 GB in DVD, and are likely to reach some 25 GB for upcoming systems based on blue laser diodes.

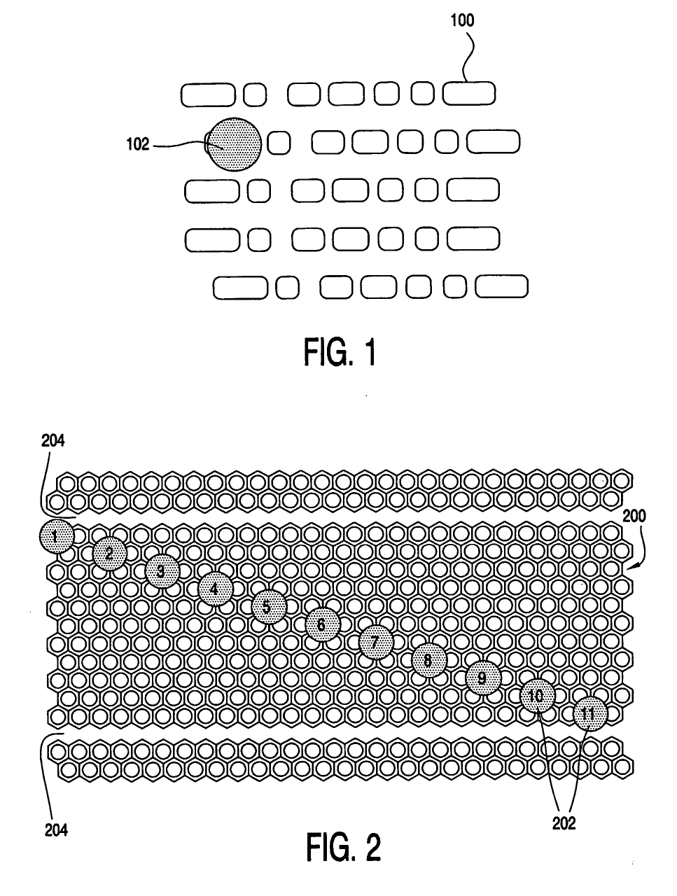

Referring to FIG. 1 of the drawings, in existing optical recording systems, data is converted into a serial data stream that is recorded on a single track 100, with ample spacing between adjacent tracks so as to avoid inter-track interference. A single read-out spot 102 is provided and the signal is sampled along the track. Normally, the cross-talk from neighbouring tracks is seen as noise. As no radial information is available (because there is only tangential sampling of the waveform), only the projection of the energy distribution of the spot 102 along the track 100 can be constructed. From this information, it is difficult to extract information about aberrations, because due to projection, they can no longer be reconstructed unambiguously.

In any event, the spacing between tracks 100 limits attainable storage capacity, while the serial nature of the data in a one-dimensional optical storage system limits the attainable data throughput. As a result, the concept of two dimensional optical storage (TwoDOS) has been developed, which is based on innovative two-dimensional channel coding and advanced signal processing, in combination with a read-channel consisting of a multi-spot light path realising a parallel read-out. TwoDOS is expected to achieve a capacity of at least 50 GB for a 12 cm disc, with a data rate-of-at least 300 Mb/s.

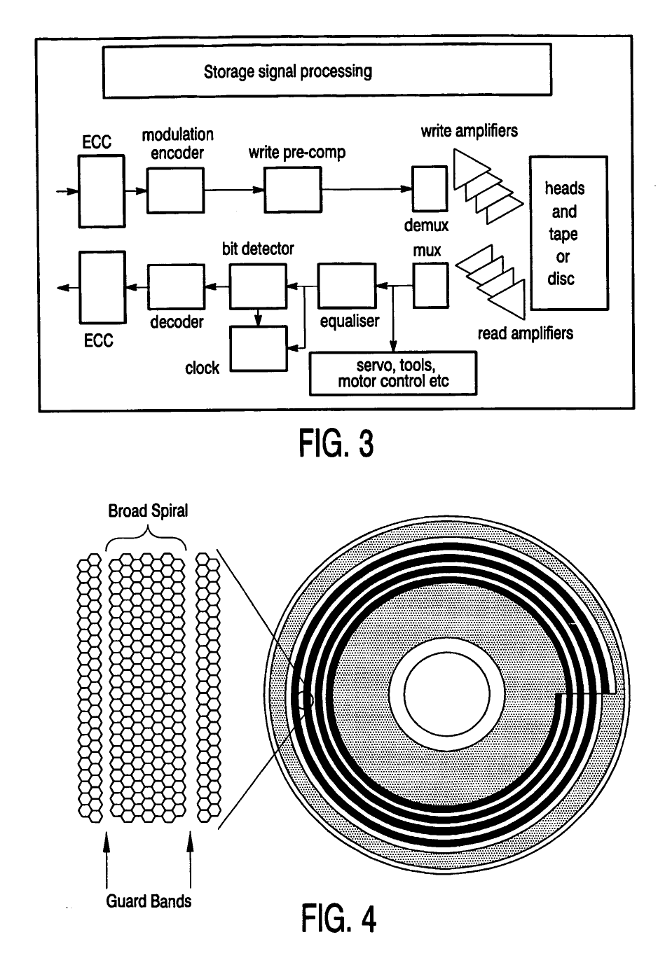

Referring to FIG. 2 of the drawings, in general, the format of a TwoDOS disc is based on a broad spiral, in which the information is recorded in the form of two-dimensional features. Parallel read-out is realised using multiple light sources. This can be generated, for instance, by a single laser beam which passes through a grating and produces an array of laser spots 202. Other options include the use of a laser array or fibre optic arrangement, for example. The information is written in a 2D way, meaning that there is a phase relation between the different bit rows. In FIG. 2, a honeycomb structure 200 is shown, and this can be encoded with a two dimensional channel code, which facilitates bi-detection. As shown, the data is contained in a broad meta-track, which consists of several bit rows, wherein the broad meta-track is enclosed by a guard band 204 (i.e. a space containing no data). The array of spots 202 scans the full width of the broad spiral. The light from each laser spot is reflected by the two dimensional pattern on the disc, and is detected on a photo-detector integrated circuit, which generates a number of high-frequency signal waveforms. The set of signal waveforms is used as the input to a two dimensional signal processing unit, such as that illustrated schematically in FIG. 3 of the drawings. The parallelism of the above-described arrangement greatly increases attainable data throughputs and permits individual data tracks to be spaced contiguously with no inter-track spacing. However, it will be appreciated that all coding and signal processing operations need to account not only for the temporal interaction between neighbouring bits, but also for their spatial (cross-track) interaction. Consequently, the entire recording system becomes fundamentally two-dimensional in nature.

It is an object of the present invention to provide a method and apparatus for two-dimensional optical storage of data, in which optical aberrations of an optical read-out spot can be retrieved.

Thus, in accordance with the present invention, there is provided a method of two-dimensional optical storage of user data on an optical storage media, the method comprising writing user data to said media and providing one or more calibration bits, in addition to said user data, at one or more known locations on said media.

Also in accordance with the present invention there is provided a method of reading out user data stored on an optical storage media on which user data is stored in a two-dimensional format and on which one or more calibration bits, in addition to said user data, are provided at known locations, the method comprising successively illuminating portions of said optical storage media with incident electromagnetic radiation, reconstructing said user data from electromagnetic radiation reflected therefrom, determining a signal waveform in respect of electromagnetic radiation reflected from said one or more calibration bits, and reconstructing therefrom the electric field distribution of said radiation reflected from said one or more calibration bits.

Preferably, a matrix multiplication is performed on said signal waveform to obtain linear interference coefficients, from which the electric field distribution of said radiation reflected from said one or more calibration bits is reconstructed. The method preferably further comprises retrieving from the electric field distribution aberrations in respect of the incident electromagnetic radiation. The method may comprise determining a centre of mass of the electric field distribution of electromagnetic radiation reflected from the one or more calibration bits and determining therefrom radial offset and/or tilt of the optical storage media and/or the incident electromagnetic radiation. The method may comprise determining an intensity of the electric field distribution of electromagnetic radiation reflected from the one or more calibration bits, and determining therefrom a value for spherical aberration and/or defocus of the incident electromagnetic radiation. In this case, the method may further include the step of determining the ellipticity of the intensity, and determining therefrom a level of astigmatism of the incident electromagnetic radiation.

The present invention further extends to apparatus for reading out user data stored on an optical storage media on which user data is stored in a two-dimensional format and on which one or more calibration bits, in addition to said user data, are provided at known locations, the apparatus comprising means for successively illuminating portions of said optical storage media with incident electromagnetic radiation, means for reconstructing said user data from electromagnetic radiation reflected therefrom, means for determining a signal waveform in respect of electromagnetic radiation reflected from said one or more calibration bits, and means for reconstructing therefrom the electric field distribution of said radiation reflected from said one or more calibration bits.

In a preferred embodiment, the apparatus may include means for identifying from the signal waveform aberrations in respect of the incident electromagnetic radiation. Means are preferably provided for correcting for the identified aberrations.

The present invention extends still further to a two-dimensional optical storage medium for receiving and storing user data in a two-dimensional format, on which is provided one or more calibration bits at known locations thereon.

As illustrated in FIG. 2 of the drawings, in two-dimensional optical storage information, the bits are placed so close to each other that intersymbol interference from tangential and radial directions influences the signal waveforms. Where in one-dimensional optical storage this is seen as noise, in two-dimensional optical storage this is seen as extra information. In fact, it enables the waveforms to be additionally sampled in the radial direction. This makes it possible to reconstruct the energy distribution of the optical spot at the two-dimensional plane of the disc and, because two-dimensional information is available, the optical aberrations can be more easily retrieved. In accordance with the invention, this energy distribution can be obtained by reading out known bit patterns (calibration bits), which can be distributed in low density on the disc. The energy distribution of the spot on the disc can be reconstructed and, from this, the aberrations of the spot can be retrieved, which can then be corrected for by changing parameters in the light path or by adjusting the equaliser or target response in the signal detection system, for example.

Thus, in a preferred embodiment of the invention, at certain places on the disc, calibration pits are placed, for instance in the lead-in and/or additionally sparsely in the data. The signal waveform resulting from the read out of the calibration bits is measured, and matrix multiplication is performed on these signals to obtain the linear interference coefficients. This can be done since the bit sequence is known (along all of the bit-rows of the 2D patterns). From these linear interference coefficients, the electric field distribution of the read-out spots at the pitholes can be reconstructed. This information can be used in at least two ways:

The signal processing unit can use this as input for its settings, so it uses a measured response of the optical channel instead of an expected response.

The OPU settings can be adapted in order to optimise spot shape and reduce aberrations.

These and other aspects of the present invention will be apparent from, and elucidated with reference to, the embodiment described herein.

An embodiment of the present invention will now be described by way of example only and with reference to the accompanying drawings, in which:

FIG. 1 is a schematic illustration of data storage in a one-dimensional optical storage arrangement;

FIG. 2 is a schematic illustration of data storage in a two-dimensional optical storage arrangement;

FIG. 3 is a schematic block diagram of a signal processing unit suitable for use in a two-dimensional optical storage arrangement;

FIG. 4 illustrates a schematic format for 2D optical storage (for simplicity, a seven-row broad spiral is shown), wherein each hexagon corresponds to a bit cell;

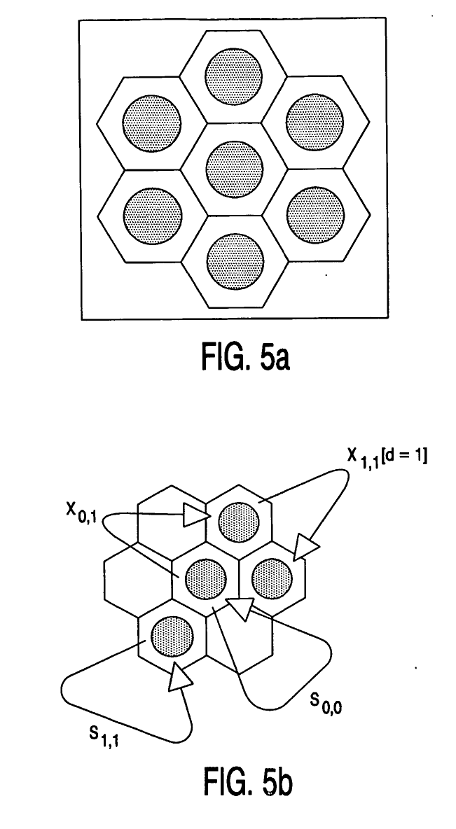

FIG. 5a is a schematic representation of a seven-bit hexagonal bit cluster; and

FIG. 5b illustrates two types of bilinear interference of wave fronts on the seven-bit hexagonal cluster of FIG. 5a: self-interference s_{0,0} and s_{1,1} and cross-interference x_{0,1} and x_{1,1}.

Thus, a new concept for two-dimensional optical storage is being developed in which the information on the disc fundamentally has a two-dimensional character. The aim is to achieve an increase over the third generation of optical storage [Blu-ray Disc (BD) with wavelength λ=405 nm and a NA of 0.85] by a factor of 2 in data density and by a factor of 10 in data rate (for the same physical parameters of the optical readout system).

As explained above, in this new concept, the bits are organised in a broad spiral. Such a spiral consists of a number of bit rows stacked one upon another with a fixed phase relation in the radial direction, such that the bits are arranged on a two-dimensional lattice. A two-dimensional closed-packed hexagonal ordering of the bits is chosen because it has a 15% higher packing fraction than the square lattice.

Successive revolutions of the broad spiral are separated by a guard band consisting of one empty bit row, as shown in FIG. 4 of the drawings. A multispot light path for parallel readout is realised, where each spot has BD characteristics. Signal processing with equalisation, timing recovery and bit detection is carried out in a two-dimensional fashion, i.e. jointly over all the bit rows within the broad spiral.

A characteristic feature of two-dimensional optical storage is that the distance of a bit to its nearest neighbouring bits is identical for all (tangential and radial) directions. As a result, a problem known as “signal folding” may arise when the pit mark for a pit bit is assumed to cover the complete hexagonal bit cell. For a large contiguous pit area consisting of a number of neighbouring pit bits, there is no diffraction at all. Consequently, a large pit area and a large non-pit (or “land”) area will show identical readout signals because they both act as perfect mirrors. As a result the channel becomes highly non-linear, and a non-linear signal processing model for scalar diffraction has been developed in which the signal levels for all possible hexagonal clusters are calculated (see M. J. Coene, Nonlinear Signal-Processing Model for Scalar Diffraction in Optical Recording, 10 Nov. 2003, Vol. 42, No. 32, APPLIED OPTICS):
I=1−Σcᵢbᵢ−2Σdᵢⱼbᵢbⱼ
i i<j

where bᵢ is the bit value (0 or 1) indicating the presence of a pithole at site I, cᵢ are the linear coefficients, and dᵢⱼ are the nonlinear coefficients describing the signal response of the bit pattern on the disc.

The above-mentioned signal-processing model yields linear and bilinear terms. Among the bilinear terms, there are self-interference terms for each pit bit (close enough to the centre that the bit is within the area of the illuminating spot), and cross-interference terms for each pit pair (with both pit bits within the area of the illuminating spot). Thus, Referring to FIG. 5a of the drawings, a schematic representation is provided of the hexagonal structure and the corresponding bits. For the signal reconstruction, the bits close to the central bit are important. In the illustration, the nearest neighbours are shown. The central bit is labelled b₀ and the surrounding bits are labelled b₁ to b₆. With the help of the above-mentioned equation, the electric field on the disc can be reconstructed. Referring to FIG. 5b of the drawings, two types of bilinear interference of wave fronts on the seven-bit hexagonal cluster are illustrated: self-interference s_{0,0} and s_{1,1}, and cross-interference x_{0,1} and x_{1,1}.

In accordance with the invention, it is proposed to provide at certain positions on an optical disc, known bit patterns, in addition to the data itself, for example, in the lead-in and/or sparsely in between data. At these positions, it is possible to extract the energy distributions of the spot (at the known position(s) of these bit patterns) and, from that, the aberrations. This information can be used to properly align the light path. For instance, disc tilt or defocus could be measured and hence be adjusted so that this error becomes minimal. This information can also be used for the signal processing unit, to adjust the target response of the equaliser, and hence the expected response of the channel.

In more detail, and referring to the above-described equation, it can be demonstrated that the linear coefficients, cᵢ, are a measure for the field distribution, at the disc for a pithole at site i. Thus, if the bit sequence is known, and the resulting waveforms are measured, then the above equation can be used to fit for the coefficients cᵢ, (and dᵢⱼ). It will be appreciated by a person skilled in the art that the above equation is linear in its coefficients c and d, so a simple matrix inversion is sufficient. This inversion can be pre-computed as the bit pattern is known, thereby resulting in a low complexity algorithm.

In particular, useful quantities which can be retrieved from the linear coefficients using the present invention are:

The centre of mass of the field at the disc, which can be translated to radial offset/tilt. This quantity is obtainable from a linear sum of the c coefficients, multiplied by the (known) spatial coordinates of the pit.

The spread of the intensity [(x²+y²)E(x,y)], i.e. the second order moment of the linear coefficients c, which relates to spherical aberration and defocus.

The ellipticity of the intensity, i.e. (xˆ2−yˆ2)E(x,y). This relates to astigmatism.

The present invention can be used in many different two-dimensional optical storage applications, including optical storage devices such as chipsets, OPU lightpaths, and disc media. In fact, it is envisaged that in future standardisation of two-dimensional optical storage, the presence of calibration bits according to the present invention may become a necessity for a 2D disc.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method of two-dimensional optical storage of user data on an optical storage media, the method comprising writing user data to said media and providing one or more calibration bits, in addition to said user data, at one or more known locations on said media.

2. A method of reading out user data stored on an optical storage media on which user data is stored in a two-dimensional format and on which one or more calibration bits, in addition to said user data, are provided at known locations, the method comprising successively illuminating portions of said optical storage media with incident electromagnetic radiation, reconstructing said user data from electromagnetic radiation reflected therefrom, determining a signal waveform in respect of electromagnetic radiation reflected from said one or more calibration bits, and reconstructing therefrom the electric field distribution of said radiation reflected from said one or more calibration bits.

3. A method according to claim 2, wherein a matrix multiplication is performed on said signal waveform to obtain linear interference coefficients, from which the electric field distribution of said radiation reflected from said one or more calibration bits is reconstructed.

4. A method according to claim 3, further comprising retrieving from the electric field distribution aberrations in respect of the incident electromagnetic radiation.

5. A method according to claim 2, comprising determining a centre of mass of the electric field distribution of electromagnetic radiation reflected from the one or more calibration bits and determining therefrom radial offset and/or tilt of the optical storage media and/or the incident electromagnetic radiation.

6. A method according to claim 2, comprising determining an intensity of the electric field distribution of electromagnetic radiation reflected from the one or more calibration bits, and determining therefrom a value for spherical aberration and/or defocus of the incident electromagnetic radiation.

7. A method according to claim 6, further including the step of determining the ellipticity of the intensity, and determining therefrom a level of astigmatism of the incident electromagnetic radiation.

8. Apparatus for reading out user data stored on an optical storage media on which user data is stored in a two-dimensional format and on which one or more calibration bits, in addition to said user data, are provided at known locations, the apparatus comprising means for successively illuminating portions of said optical storage media with incident electromagnetic radiation, means for reconstructing said user data from electromagnetic radiation reflected therefrom, means for determining a signal waveform in respect of electromagnetic radiation reflected from said one or more calibration bits, and means for reconstructing therefrom the electric field distribution of said radiation reflected from said one or more calibration bits.

9. Apparatus according to claim 8, further including means for identifying from the signal waveform aberrations in respect of the incident electromagnetic radiation.

10. Apparatus according to claim 9, comprising means for correcting for the identified aberrations.

11. A two-dimensional optical storage medium for receiving and storing user data in a two-dimensional format, on which is provided one or more calibration bits at known locations thereon.
